(19) United States
(12) Patent Application Publication
(10) Pub. No.: US 2011/0089721 A1
(43) Pub. Date: Apr. 21, 2011

(54) Module frame

(75) Inventors: Vladimir Mihalic, Novo Mesto (SI); Miha Gregorcic, Sentrupert (SI)

(73) Assignee: Plastoform Blanca II d.o.o.

(21) Appl. No.: 12/925,179

(22) Filed: Oct. 15, 2010

(30) Foreign Application Priority Data
Oct. 15, 2009 (SI) 2009/00293

(51) Int. Cl. B60R 13/02

(52) U.S. Cl. 296/201

(57) ABSTRACT

A module frame for the windows and doors (also service doors) for motor homes and/or caravans has individual profile trims (1) which form, together with adequately shaped corners (2), the module frame of desired dimensions, with the shaped corners being secured to profile trims with intermediate elements with the help of link elements.

The present invention is relates to a frame of the windows or doors. The primary usage of the present invention is for windows or door wings (also service doors) of motor homes and caravans. The module frame according to the invention is made from individually shaped frame trims in specified lengths, which with appropriately shaped edges of the frame form a module frame of a desired dimension.

The construction of module frame for window efficiently solves the technical problem of guaranteeing a simple and rational manufacturing of window and door frames in different dimensions with appropriately made sealing.

The problem, which by manufacturing and installation of different sizes of windows and doors with frames, mostly by motor homes and caravans, lies in the necessity of each window dimension to have an adequate frame, through which the window is installed, in the wall of the motor home or caravan.

The frame has to be made in a way that it guarantees an appropriate sealing, that is why the sides of the frame are made as individual profile fields or the sides are made from multiple profile (aluminium or similar material), which is very hard to shape, especially in the edges of the frame. The manufacturing of the frame for each dimension of the window individually does not enable a rational use of material. Besides, for every dimension of the window, there has to be an adequate frame in stock or an adequate tool for manufacturing the frame.

Module frame of the window according to the invention, primarily for the windows and doors (also service doors) of motor homes and/or caravans, allows to solve this technical problem by making the frame from individual frame trims which, with the help of adequately shaped corners, provide a module frame of any wanted dimension. These dimensions of the frame can be set with dimension of individual trims and, therefore, the size of the frame can be adjusted to the size of the windows or doors.

The invention will be explained in detail on the basis of an embodiment and related drawings, which show:

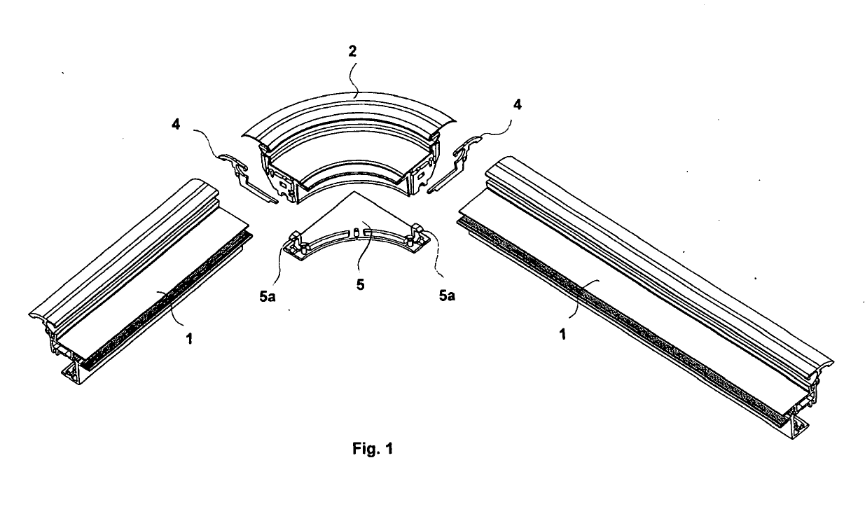

FIG. 1 a front view of a corner part of a module frame according to the invention in a set apart position;

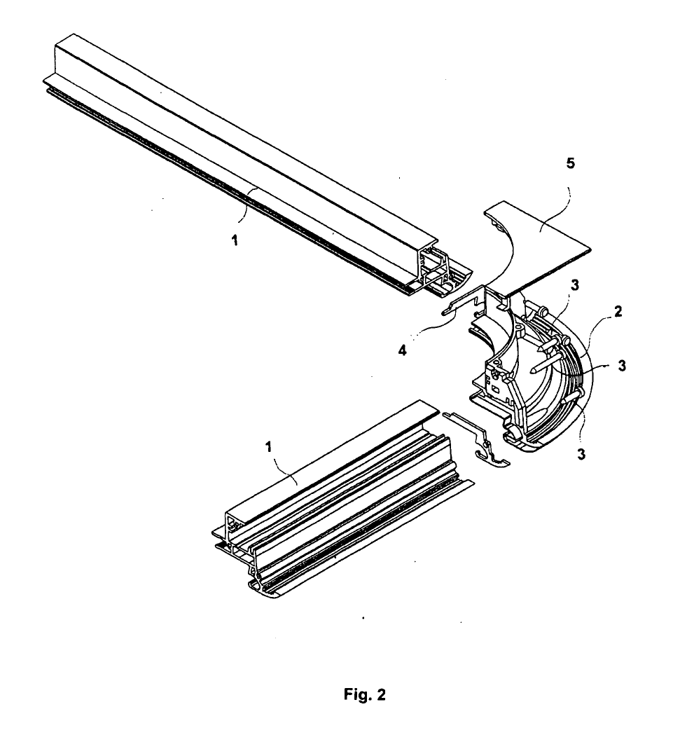

FIG. 2 a bottom view of the corner part of the module frame according to the invention in the set apart position; and

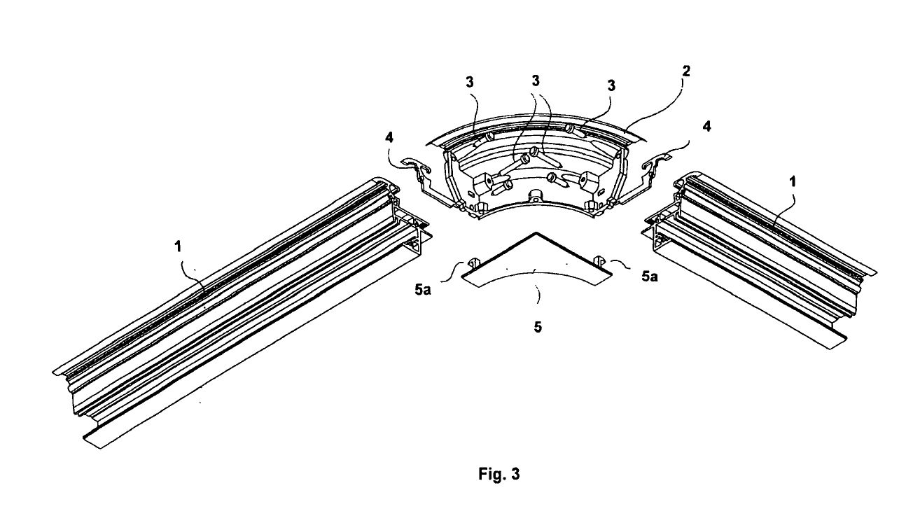

FIG. 3 a rear view of the corner part of the module frame according to the invention in the set apart position.

A module frame according to the invention is formed from side elements, in the form of trims 1 with selected lengths and corners 2. Each trim 1 is made as multi-profile trim, and its profiles insure adequate sealing, insertion of the sealing rubber, etc. and setting of the frame on the edge of the wall or ceiling opening. Trims 1 have their lengths adjusted according to the dimension of the windows or doors and are formed, with corners 2, into the module frame. Because of the usage of the corner 2, the profile trim 1 is not curved and, therefore, its profiles can be adapted for installation into the wall of the motor home and/or caravan, thereby fulfilling all sealing and firmness demands.

The corner 2 at both its ends completes a multi-profile shape of profiled trim 1 and is made in a way that it can be easily connected to the profile trims 1 with the help of adequate link elements 3. The corner 2 is fixed at the end of the profile trim 1 by an intermediate element 4, which is shaped in a way that it closes the profile trim 1 and prevents the infiltration of moisture, dust or other impurities into the profile trim 1.

After the firming of the corner 2 with profiled trims 1, a cover 5 is mounted on the corner 2 from the inner side. The cover 5 of the corner 2 is fixed on the corner 2 with the help of hasp elements 5a. This prevents the infiltration of moisture, dust and other impurities into the corner 2. Besides that cover 5 appropriately ends the inner area of the frame.

1-2. (canceled)

3. A module frame for windows or doors, comprising an individual profile trim of the frame; at least one corner having a shape corresponding to a trim profile; at least one intermediate element for securing the corner with the profile trim; and at least one link element for facilitating attachment of the profile trim to the corner.

4. A module frame according to claim 3, further comprising a cover secured on an inner side of the corner; and at least one hasp element for securing the cover to the corner.
